(19) United States
(12) Patent Application Publication
(10) Pub. No.: US 2004/0241552 A1
(43) Pub. Date: Dec. 2, 2004

(54) Vanadium redox battery electrolyte

(76) Inventor: Maria Skyllas-Kazacos, Sylvania Heights (AU)

Correspondence Address: WELSH & KATZ, LTD, 120 S RIVERSIDE PLAZA, 22ND FLOOR, CHICAGO, IL, 60606, US

(21) Appl. No.: 10/477,017

(22) PCT Filed: May 17, 2002
(86) PCT No.: PCT/AU02/00613

(30) Foreign Application Priority Data
May 18, 2001 (AU) PR5129
May 21, 2001 (AU) PR5143

(51) Int. Cl. H01M 6/18; C01G 31/02

(52) U.S. Cl. 429/304; 423/594.17

(57) ABSTRACT

The present invention relates generally to the production of a vanadium electrolyte, including a mixture of trivalent and tetravalent vanadium ions in a sulphuric acid solution, by the reactive dissolution of vanadium trioxide and vanadium pentoxide powders, the surface area and particle size characteristics being controlled for complete reaction to produce the desired ratio of V(III) to V(IV) ions in the solution. The solution may be suitable for direct use in the vanadium redox battery, or the solution can provide an electrolyte concentrate or slurry which can be reconstituted by the addition of water or sulphuric acid prior to use in the vanadium redox battery.

### FIELD OF THE INVENTION

The present invention relates generally to a process for producing a vanadium electrolyte typically for use in a vanadium redox battery.

### BACKGROUND TO THE INVENTION

International patent application Nos. PCT/AU94/00711 and PCT/AU96/00268 both by Skyllas-Kazazos and Kazacos describe the following respective methods for producing a vanadium electrolyte currently used in research and demonstration scale projects for the vanadium redox battery:

1. Leaching/Electrolysis

This involves the use of V(III) ions or an other chemical reductant to chemically reduce and dissolve vanadium pentoxide in sulphuric acid to produce a V(IV) solution. This V(IV) solution is then passed through an electrolytic cell to reduce it to a 50:50 mixture of V(III) and V(IV) ions (referred to as V^{3.5+}). Part of this 50:50 mixture is recycled to the vanadium pentoxide leaching tank for further oxide dissolution, while the rest goes to product.

2. Vanadium Trioxide/Vanadium Pentoxide Reaction

In this process, equimolar quantities of the pentoxide and trioxide powders are mixed and allowed to react in boiling sulphuric acid for 20 to 30 minutes, followed by heat treatment for a further 1-2 hours, a final V(IV) solution can thus be obtained which needs to be electrolytically or chemically reduced further so that a 50:50 mixture of V(III) and V(IV) can be obtained suitable for use in a vanadium battery.

### SUMMARY OF THE INVENTION

According to the present invention there is provided a process for producing a vanadium electrolyte, the process comprising a reactive dissolution of vanadium trioxide and vanadium pentoxide powders, each being of a predetermined surface area and/or particle size, to directly produce a mixture of trivalent and tetravalent vanadium ions, wherein at least one of the vanadium trioxide powder or the vanadium pentoxide powder has a predetermined surface area of at least 0.1 m²/g or a predetermined particle size of at most 50 microns.

Generally the reactive dissolution of vanadium trioxide and vanadium pentoxide is conducted in the presence of sulphuric acid.

Preferably the vanadium trioxide and vanadium pentoxide powders are reacted in a molar ratio of about 3 to 1 to allow complete reaction. More preferably the ratio of trivalent vanadium ions to tetravalent vanadium ions in the mixture of trivalent and tetravalent vanadium ions is approximately 50:50.

Typically the predetermined surface area of the vanadium trioxide powder and the vanadium pentoxide powder is at least 0.1 m²/g. More typically, the predetermined surface area of the vanadium trioxide powder and the vanadium pentoxide powder is greater than 1.0 m²/g.

Preferably the predetermined particle size of the vanadium trioxide powder and the vanadium pentoxide powder is at most 50 microns. More preferably the predetermined particle size of the vanadium trioxide powder and the vanadium pentoxide powder is less than 15 microns.

Preferably the reactive dissolution is performed at a temperature above 30° C. More preferably the reactive dissolution is performed at above 90° C.

Typically the reactive dissolution is conducted for a time of between 10 minutes to 10 hours. More typically the reactive dissolution is conducted for between 0.5 to 3 hours.

Typically the process also comprises the step of reconstituting the mixture of trivalent and tetravalent ions with an acid and/or water to provide the vanadium electrolyte. Alternatively the vanadium electrolyte is produced directly from the reactive dissolution of the vanadium trioxide and vanadium pentoxide powders in the presence of sulphuric acid.

Preferably the total vanadium concentration of the vanadium electrolyte product of this process is between 0.5 and 12 Molar (M). More preferably the total vanadium concentration is between 1.5 and 6 M.

Typically the process further comprises the step of stabilising the vanadium electrolyte by the addition of a stabilising agent before, during or after the reactive dissolution. More typically the stabilising agent includes ammonium phosphate, ammonium sulphate, phosphoric acid or combinations thereof.

Generally the vanadium electrolyte is used in a vanadium redox battery.

It will thus be appreciated that at least a preferred embodiment of the present invention defines critical characteristics of the vanadium oxide raw materials needed to produce the vanadium battery electrolyte (i.e. 50:50 mixture of V(IV) and V³⁺ ions) via a single step process which does not require an electrolysis or a chemical oxidation or reduction step to produce the required oxidation state for direct use in the vanadium redox battery. This material enables the electrolyte to be produced at the user end and avoids significant transportation costs. The process in at least its preferred form can be used to produce battery grade vanadium electrolyte using raw material. This process can be used to produce vanadium battery electrolyte directly of the required concentration and composition, but it can also be used to produce a vanadium concentrate which can be reconstituted before use in a vanadium battery system.

### DETAILED DESCRIPTION OF THE PREFERRED EMBODIMENTS

The invention relates particularly, though not exclusively to the production of a vanadium electrolyte, including a mixture of trivalent and tetravalent vanadium ions in a sulphuric acid solution, by the reactive dissolution of vanadium trioxide and vanadium pentoxide powders, the surface area and particle size characteristics being controlled for complete reaction to produce the desired ratio of V(III) to V(IV) ions in the solution. The solution may be suitable for direct use in the vanadium redox battery, or the solution can provide an electrolyte concentrate or slurry which can be reconstituted by the addition of water or sulphuric acid prior to use in the vanadium redox battery.

Studies undertaken by the inventor with a variety of vanadium oxide powders from various sources surprisingly revealed that, when certain powders were used, it was possible to combine the V(III) and V(V) oxides in the appropriate ratio so as to directly produce the desired 50:50 mixture of V(III) and V(IV) which is needed for the vanadium redox flow cell electrolyte. Detailed studies revealed that this can only be achieved if the oxide powders possess the necessary surface area and/or particle size to permit full reaction to the V^{3.5+} oxidation state. If the particle size and surface area are outside the required ranges, however, only partial reaction will occur leading to a V(IV) solution which requires further reduction to give the V^{3.5+} electrolyte.

A number of sources of the oxide powders were tested as raw material for this process. These include oxide powders supplied by Vanadium Australia, by Kashima-Kita Electric Power Corporation and material purchased from Highveld in South Africa and Treibacher in Austria. While the Vanadium Australia and Kashima-Kita powders possessed the necessary properties for complete reaction, the Highveld and Treibacher products tested at the time did not. Further studies were undertaken to characterise the vanadium oxide powders produced by Vanadium Australia and Kashima-Kita, to determine their surface area and particle size characteristics so that a detailed specification for each oxide raw material could be established. This material was suited to the one-step production of a vanadium redox cell electrolyte which does not require a further oxidation or reduction step to yield the 50:50 mixture of V(III) and V(IV) ions as is required for direct application in the vanadium redox battery.

It is also important to be aware of the effect of impurities on the cyclic performance of the vanadium redox battery. Metals such as Fe, Mo, Ni, Cu, Cd, Sn, Cr, Mn and Zn are known to catalyse hydrogen evolution in some instances and this may create problems during cycling of the vanadium battery. For example, if only 1% of the charging current were to go into hydrogen evolution, the loss in coulombic efficiency would be negligible at 1%, however, this would be accompanied by a 1% capacity loss per cycle, as the positive and negative half-cell solutions go out of balance. Hydrogen evolution during charging should therefore be avoided. Any detrimental effects on the reversibility of the vanadium redox couples will also lower the overall energy efficiency of the system. Other impurities such as silica should also be kept as low as possible to avoid membrane fouling problems during operation of the vanadium redox cell.

Methodology

1. Oxide Dissolution Studies

The dissolution rates of the vanadium trioxide and pentoxide powders were studied as a function of temperature. A 2:1 molar ratio of vanadium trioxide and vanadium pentoxide were added to a preheated solution of sulphuric acid of concentration ranging from 3 M to 10 M. The total amount of vanadium was varied so that final vanadium concentrations between 0.5 and 10 M could be obtained after complete reaction. At room temperature, the reaction rates were found to be very low, however, as the temperature was increased above 30° C., the reaction rate increased. At temperatures of around 80° C. or higher, the reaction rate increased dramatically as considerable-heat was generated by the exothermic reaction between the V(III) ions produced by the vanadium trioxide and the V(V) ions from the vanadium pentoxide. This caused the temperature to increase until the reaction mixture boiled and overflowed in the reaction vessel. To control the process, it was thus found necessary to slowly add the powders to the reaction vessel so that the amount of heat generated could be minimised. Alternatively, slow heating of the reaction mixture was needed to control the reaction and avoid overflow problems. The powders appeared to fully dissolve after approximately 30 minutes at 0.80-120° C. However, to ensure the reactions went to completion, a minimum reaction time of 2-4 hours was allowed. The reaction mixtures were then filtered to remove any undissolved solids and cooled to room temperature before the final vanadium concentration and oxidation state were determined by potentiometric titration with potassium permanganate. The total sulphate concentration was determined by Inductively Coupled Plasma analysis.

2. Vanadium Electrolyte Concentrate Process

Using the data obtained in the above oxide reaction studies, a bench-scale process for producing a 3-8 M vanadium electrolyte concentrate using the vanadium trioxide and vanadium pentoxide powders was developed. The possibility of attaining up to 8-10 moles per litre vanadium sulphate slurry was also explored, together with the reconstitution processes to produce battery grade solution.

3. Surface Area and Particle Size Analysis

Vanadium trioxide and pentoxide powders from Kashima-Kita Electric Power Corporation and from Vanadium Australia were analysed to determine their particle sizes and surface areas. These measurements provided the basis from which to specify the required characteristics of the oxide powder for the one-step reactive dissolution process for the direct production of a 50:50 mixture of V(III) and V(IV) ions or suspended slurry in the sulphuric acid supporting electrolyte.

For the complete reaction of vanadium trioxide and vanadium pentoxide powders to produce a 50:50 mixture of V(III) and V(IV) ions or suspended slurry, the minimum surface area of each of the oxide powders was 0.1 m²/g. Preferably this should be above 0.2 m²/g, or more preferably above 0.5 m²/g, even more preferably above 0.7 or 1.0 m²/g. Even more typically, the required surface area of the oxide powder or powders should be selected from the group comprising greater than 0.1, 0.2, 0.3, 0.4, 0.5, 0.6, 0.7, 0.8, 0.9, 1.0, 1.1, 1.2 and 1.3 m²/g. For complete reaction, the maximum particle size of the oxide powder or powders should be selected from the group consisting of 50, 45, 40, 35, 30, 25, 20 or 15 microns. Even more typically the particle size should be in the range selected from below 20 or below 15 microns and even more typically below 15 microns. For faster reaction rates, it is preferred that both vanadium trioxide and vanadium pentoxide powders meet the above surface area and particle size requirements. The process can still be performed if at least one of the powders has the specified surface area and particle size, as long as the reaction time is increased at the higher temperatures above 60 or 80° C.

The sulphuric acid concentration required to produce the disclosed battery grade vanadium electrolyte was between 2 M and 12 M, or 2 M and 10 M or 2 M and 9 M or 2 M and 8 M or 2 M and 7 M or 2 M and 6 M or 2 M and 5 M or 2 M and 4 M. More typically the sulphuric acid concentration required for this process should be between 3 M and 10 M 3 M and 9 M or 3 M and 8 M or 3 M and 7 M or 3 M and 6 M or 3 M and 5 M or 3 M and 4 M. Even more typically, the sulphuric acid concentration should be between 4 M and 10 M, or 4 M and 9 M or 4 M and 8 M or 4 M and 7 M or 4 M and 6 M or 4 M and 5 M or 5 M and 6 M or 5 M and 7 M. Even more preferably the sulphuric acid concentration should be between 4 M and 6 M.

The final total vanadium concentration that can be prepared by the methods of the preferred embodiments of the invention can vary from between 0.5 M and 12 M, or more typically can be selected from the group comprising 0.5 M to 12 M, 0.5 M to 10 M, 0.5 M to 8 M. 0.5 M to 7 M, 0.5 M to 6 M, 0.5 to 5 M, 0.5 to 4 M, 0.5 to 3 M, 0.5 to 2.5 M, 0.5 to 2.0, 0.5 to 1.8, 0.5 to 1.7, 0.5 to 1.6, 1 M to 12 M, 1 to 10 M, 1 to 9 M, 1 to 8 M, 1 to 7 M, 1 to 6 M, 1 to 5 M, 1 to 4 M, 1 to 3 M, 1 to 2.5 M, 1 to 2, 1.5 to 12 M, 1.5 to 10 M, 1.5 to 8 M, 1.5 to 7 M, 1.5 to 6 M, 1.5 to 5 M, 1.5 to 4 M, 1.5 to 3 M, 1.5 to 2.5 M, 1.5 to 2 M or 1.8 to 12 M, 1.8 to 10 M, 1.8 to 8 M, 1.8 to 7 M, 1.8 to 6 M, 1.8 to 5 M, 1.8 to 4 M, 1.8 to 3 M, 1.8 to 2.5 M, 1.8 to 2 M, 2 to 12 M, 2 to 10 M, 2 to 8 M, 2 to 7 M, 2 to 6 M, 2 to 5 M, 2 to 4 M, 2 to 3 M, 2 to 2.5 M, 3 to 12 M, 3 to 10 M, 3 to 8 M, 3 to 7 M, 3 to 6 M, 3 to 5 M, 3 to 4 M or 4 to 5 M or 4 to 6 M or 4 to 6 M, as either a solution or suspended slurry.

The solution temperature can be selected from above 30, 40, 50, 60, 70, 80 or 90° C. but more preferably it was above 70 or above 80 or above 90° C. Even more typically, the reaction mixture was maintained at the boiling temperature of the solution. The reaction time was selected from the group consisting of between 10 minutes and 10 hours, or between 10 minutes and 5 hours, or between 10 minutes and 4 hours or between 10 minutes and 3 hours or between 10 minutes and 2.5 hours or between 10 minutes and 2 hours or between 10 minutes and 1.5 hours or between 10 minutes and 1 hour. More typically the reaction time was selected from the group consisting of between 15 minutes and 10 hours or between 15 minutes and 5 hours, or between 15 minutes and 4 hours or between 15 minutes and 3 hours or between 15 minutes and 2.5 hours or between 15 minutes and 2 hours or between 15 minutes and 1.5 hours or between 15 minutes and 1 hour. Even more typically the reaction time was selected from the group consisting of 30 minutes and 10 hours or between 30 minutes and 5 hours, or between 30 minutes and 4 hours or between 30 minutes and 3 hours or between 30 minutes and 2.5 hours or between 30 minutes and 2 hours or between 30 minutes and 1.5 hours or between 30 minutes and 1 hour. Even more typically for the higher vanadium concentration solutions or slurries, the reaction time was 1 hour to 1.5 hours or 1 hours to 2 hours or 1 hour to 2.5 hours or 1 hour to 3 hours or 1 to hours or 1 to 7 hours or 2 hours to 3 hours, or 2 to 5 hours or 3 to 5 hours.

As a stabilising agent to reduce the rate of precipitation from a supersaturated vanadium solution produced by the above method during storage, transport or during use in the vanadium redox battery, small amounts of ammonium phosphate, ammonium sulphate or phosphoric acid can be added to the reaction mixture before or after the vanadium oxide powders are introduced. These additives act as precipitation inhibitors and were added in concentrations of between 0.1 and 5 weight percent or 0.5 and 5 weight percent or between 0.5 and 3 weight percent or between 0.1 and 5 mole percent or between 0.5 and 5 mole or between 0.5 and 3 mole percent or between 0.5 and 2 mole percent.

While the ideal ratio of V(III) to V(IV) in the final solution produced by the described methods of the invention is 50:50, it should be recognised that this may not always be exactly the case. For example, any ratio between 40:60 and 60:40 V(III) to V(IV) in the final vanadium electrolyte would provide acceptable operational requirements for the vanadium redox battery and are included in the scope of this invention.

Samples of vanadium pentoxide supplied by Vanadium Australia and Kashima-Kita Electric Power Corporation were analysed for particle size and surface area and the following results were obtained:

TABLE 1
V₂O₅ Powder Analysis
V₂O₅ Sample

| | Vanadium | | |
|---|---|---|---|
| | Australia | Vanadium | Kashima-Kita |
| Physical | Double | Australia Ion | Electric Power |
| Property | Precipitation | Exchange | sample |
| Appearance | Orange colour, | Orange colour, | Orange colour, |
| | fine | fine | fine |
| Water Content | 0.61 | 0.74 | 2.46 |
| (%) | | | |
| Specific | 2.09 | 3.05 | 1.33 |
| Surface Area | | | |
| (m²/g) | | | |
| Particle Size | 13.23 | 14.97 | 10.44 |
| D[v,0.5]μm | | | |

(Note: V₂O₅ particle size analysis was carried out as in 0.02% water suspension.)

### EXAMPLE 1

Samples of the Treibacher, Highveld, Kashima-Kita Electric Power Corporation and Vanadium Australia vanadium pentoxide powders were reacted in a stoichiometric ratio with vanadium trioxide material from Kashima-Kita or Tribacher. The ratio was adjusted so that after complete reaction, the final V(III) to V(IV) ratio in the solution would be 50:50. The powders were slowly added to sulphuric acid solutions of various concentrations at a temperature of above 80° C. and allowed to react. On addition of each of the powders, to the hot acid solution, vigorous reaction was observed with the release of large amounts of heat.

The rate of addition was therefore carefully controlled to avoid significant overflow of the reacting mixture. The reaction was allowed to continue for up to 2 hours to ensure that complete reaction between the vanadium trioxide and vanadium pentoxide powders could be achieved. At the end of each experiment, any undissolved powder was filtered and weighed to determine what percentage had not dissolved. The oxidation state of the vanadium in each of the solutions was also measured by potentiometric titration to determine the ratio of V(III) to V(IV) in the final solution. The results are given in the following table:

TABLE 2

| | V₂O₅ Powder | | | | |
|---|---|---|---|---|---|
| | VA | | | | |
| | Double | | | | |
| | Precip- | VA Ion | Kashima- | | |
| | itation | Exchange | Kita | Treibacher | Highveld |
| Initial | 5.3 | 5.3 | 5.3 | 5.3 | 5.3 |
| sulphuric | | | | | |
| acid conc (M) | | | | | |
| Total moles | 2 | 2 | 2 | 2 | 2 |
| vanadium | | | | | |
| oxide powder | | | | | |
| Reaction Time | 2 | 2 | 2 | 2 | 2 |
| (Hours) | | | | | |
| Final | V(+3.5) | V(+3.5) | V(+3.5) | V(IV) | V(IV) |
| Oxidation | | | | | |
| State | | | | | |
| Final | 2.20 | 2.13 | 2.13 | 1.58 | 1.55 |
| Vanadium | | | | | |
| Concentration | | | | | |
| (M) | | | | | |
| Final Sulfur | 5.53 | 5.37 | 5.25 | 5.36 | 5.35 |
| concentration | | | | | |
| Undissolved | 7% | 8% | 9% | 40% | 45% |
| Powder (%) | | | | | |

### EXAMPLE 2

The above experiment was repeated using an initial sulphuric acid concentration of 6 M and a total quantity of vanadium powder concentration to produce a final solution of 4 moles per litre vanadium ions. Again, stoichiometric quantities of the different pentoxide and trioxide powders were added to the reaction vessel so that a 50:50 mixture of V(III) and V(IV) would be produced if complete reaction between the trioxide and pentoxide powders had occurred. In this case 3% H₃PO₄ was also added to the sulphuric acid as a stabilising agent to minimise the rate of precipitation of the final supersaturated vanadium solution during storage and during use in the vanadium battery. Again the same results were obtained. In the case of the Vanadium Australia and Kashima-Kita powders, almost complete reaction and dissolution of the powders was observed within the first 15 minutes. In the case of the Highveld and Treibacher powders, however, a substantial amount of undissolved powder was still present in the reaction vessel even after 2 hours of reaction at boiling point. Again, the vanadium oxidation state in the final solution was around 3.5+(i.e. 50:50 V(III)) and V(IV) for the Vanadium Australia and Kashima-Kita powders. On the other hand, the Treibacher and Highveld powders showed an oxidation state closer to that of a V(IV) solution.

### EXAMPLE 3

The experiments were repeated with an initial sulphuric acid of 6 M and 2 moles per litre of vanadium trioxide powder together with 1 mole per litre vanadium pentoxide powder. Complete reaction should have produced a final vanadium concentration of 6 M. Also added to the sulphuric acid was 2 weight % ammonium phosphate as stabilising agent to reduce the rate of precipitation of the final battery electrolyte during use in the vanadium battery. Again, the powders were slowly added to the acid solution initially heated to 80° C. As the powders were added to the reactor, a vigorous exothermic reaction occurred between the trioxide and pentoxide giving rise to an increase in temperature with the reaction mixture boiling. The reaction was allowed to react for 4 hours. Once again, only the Vanadium Australia and Kashima-Kita powders showed complete reaction even after 4 hours with a final vanadium concentration of 6 M. After cooling the reaction mixture to room temperature, considerable precipitation of vanadium sulphate was observed. On reheating this concentrate or slurry and adding a sufficient volume of 6 M sulphuric acid and/or water, it was possible to reconstitute the slurry/concentrate to produce a final vanadium electrolyte of the desired vanadium and total sulphur concentration to run in a vanadium redox battery. These solutions with vanadium concentrations ranging from 1.5 to 3 M were tested in a vanadium redox cell and overall energy efficiencies of around 80% were achieved at a charge-discharge current density of 40 mA/cm². These results are summarised in Table 4.

On the other hand, the other powders, showed incomplete reaction and dissolution with a final oxidation state close to that of a V(IV) solution.

It should be pointed out that while the different sources of vanadium oxide powders showed different reaction and dissolution rates during the production of the vanadium battery electrolyte, it should be possible for any vanadium producer to adjust their process conditions so as to achieve a product, having the predetermined surface area and/or particle size, which could be employed in the process of this invention. For example, the impurity levels as demonstrated by the assay results of Table 3 of the South African Highveld material have also been demonstrated to allow energy efficiencies of over 80% to be achieved.

TABLE 3

| | | |
|---|---|---|
| Fe | | 0.2% |
| SiO2 | | 0.02% |
| Al2O3 | | 0.2% |
| Na2O | | 0.3% |
| K2O | | 0.1% |
| S | < | 0.01% |
| P | < | 0.02% |
| TiO2 | | 0.02% |
| U | | 20 ppm |
| As | | 40 ppm |
| Ni | < | 0.005% |
| Cu | < | 0.005% |
| Mn | < | 0.005% |
| Mo | < | 0.01% |
| Cr | | 0.01% |
| Pb | < | 0.01% |

Impurity levels of the two Vanadium Australia powders and the Kashima-Kita powders were also determined and the results are shown in Table 4 below:

TABLE 4
VANADIUM ELECTROLYTE IMPURUTUES (mg/l)

| | | Double | Ion | Kashima- | |
|---|---|---|---|---|---|
| | H₂SO₄ | Precip. | Exchange | Kita | Matrix |
| Element | Background | Pentoxide | Pentoxide | Pentoxide | Interference |
| Al | <0.06 | 0.06 | 7.45 | <0.06 | yes |
| As | <1.6 | 59.9 | 61.3 | 62.4 | no |
| Ca | 0.11 | 70.2 | 55.9 | 66.4 | no |
| Cr | 0.06 | <0.05 | <0.05 | <0.05 | no |
| Cu | 0.07 | <0.01 | <0.01 | <0.01 | yes |
| Fe | 0.46 | 11.1 | 14.1 | 8.4 | no |
| K | 0.48 | 3.4 | 1.2 | 1.3 | no |
| Mn | 0.01 | 0.4 | 0.1 | 0.3 | no |
| Mo | 0.14 | <0.20 | <0.20 | <0.20 | yes |
| Na | <0.30 | <0.30 | <0.30 | <0.30 | no |
| Ni | 0.11 | 0.18 | <0.10 | 0.07 | no |
| P | 21.8 | 44 | <12.6 | <12.6 | no |
| Pb | 0.02 | <1 | <1 | <1 | yes |
| Si | 11.7 | 16.3 | 13 | 17 | no |
| Ti | 0.03 | 18.5 | 12.3 | 27.2 | no |

TABLE 5
Vanadium Redox Cell Efficiencies Using 2.00 M
vanadium solution in 5.00 M total sulfate prepared from
different vanadium pentoxide powders.

| | Coulombic | | | Potential | | | Energy | | |
|---|---|---|---|---|---|---|---|---|---|
| Cyc | Efficiency (%) | | | Efficiency (%) | | | Efficiency (%) | | |
| No. | DP | IE | KK | DO | IE | KK | DP | IE | KK |
| 1 | 98 | 96 | 96 | 79 | 79 | 84 | 78 | 77 | 81 |
| 2 | 98 | 100 | 96 | 81 | 82 | 81 | 79 | 82 | 77 |
| 3 | 98 | 96 | 98 | 81 | 82 | 81 | 79 | 79 | 79 |
| 4 | 98 | 97 | 98 | 81 | 79 | 81 | 79 | 77 | 79 |
| 5 | 98 | 96 | 98 | 81 | 81 | 79 | 79 | 78 | 77 |

In a particularly preferred process a 4-7 M solution of sulphuric acid was heated to around 80° C. and small amounts of vanadium trioxide and vanadium pentoxide powders were added to the sulphuric acid solution so that the exothermic reaction between the different oxidation states can leach the two vanadium oxide powders allowing them to dissolve into solution. For best results, the vanadium trioxide and vanadium pentoxide powders were selected so that their surface area was above 1 m²/g and average particle size was below 15 microns. The ratio of vanadium trioxide to vanadium pentoxide added was 3:1 so that on complete reaction and dissolution of the powders the final ratio of V(III) to V(IV) in the solution was 50:50. Typically 1.5 moles per litre vanadium trioxide was slowly added to 0.5 moles per litre vanadium pentoxide in the sulphuric acid solution. The heat in the exothermic reaction caused the temperature to increase to boiling. To avoid overflow of the solution, the reactor can be pressurised. The reaction was allowed to continue for between 1 and 3 hours until complete dissolution of the powders occurred and stabilisation of the solution took place. 1-3% phosphoric acid was added before or after the reaction was completed. On cooling, the solution can be stored or transport in this form and the required amounts of water or diluted acid added to produce a vanadium solution of the required composition added prior to use in the vanadium redox battery. The amount of oxide powders added can also be doubled so that a concentrate or slurry is formed, this again being reconstituted prior to being used in the battery with the addition of heat, water and/or dilute acid.

To produce a 1.8 M vanadium solution for direct use in a vanadium redox battery, 0.675 moles per litre of vanadium trioxide powder is reacted with 0.225 moles per litre of vanadium pentoxide powder in 4 to 6 M sulphuric acid. The powders can be added to the sulphuric acid solution at room temperature and the reactor temperature slowly increased. As the temperature increased above 40° C., the powders begin to react and the rate of dissolution increases, causing the temperature to increase above 80° C. Reaction is allowed to continue for 15 minutes to 1 hour until all the powder dissolves, producing a 1.8 M V^{3.5+} solution that can be used directly in the vanadium redox battery without further reconstitution or reduction. It is also recommended that either during or after the powder dissolution, 1-3 wt % phosphoric acid or ammonium phosphate is added to the electrolyte to stabilise the solution against possible precipitation during operation of the vanadium redox cell at temperatures above 40° C. or below 10° C.

It is to be understood that, if any prior art information is referred to herein, such reference does not constitute an admission that the information forms a part of the common general knowledge in the art, in Australia or any other country.

1. A process for producing a vanadium electrolyte, the process comprising a reactive dissolution of vanadium trioxide and vanadium pentoxide powders, each being of a predetermined surface area and/or particle size, to directly produce a mixture of trivalent and tetravalent vanadium ions, wherein at least one of the vanadium trioxide powder or the vanadium pentoxide powder has a predetermined surface area of at least 0.1 m²/g or a predetermined particle size of at most 50 microns.

2. A process as defined in claim 1, wherein the reactive dissolution of vanadium trioxide and vanadium pentoxide is conducted in the presence of sulphuric acid.

3. A process as defined in claim 1 or 2, wherein the vanadium trioxide and vanadium pentoxide powders are reacted in a molar ratio of about 3 to 1 to allow complete reaction.

4. A process as defined in any one of the preceding claims, wherein the ratio of trivalent vanadium ions to tetravalent vanadium ions in the mixture of trivalent and tetravalent vanadium ions is approximately 50:50.

5. A process as defined in any one of the preceding claims, wherein the predetermined surface area of the vanadium trioxide powder and the vanadium pentoxide powder is at least 0.1 m²/g.

6. A process as defined in any one of claims 1 to 4, wherein the predetermined surface area of the vanadium trioxide powder and the vanadium pentoxide powder is greater than 1.0 m²/g.

7. A process as defined in any one of the preceding claims, wherein the predetermined particle size of the vanadium trioxide powder and the vanadium pentoxide powder is at most 50 microns.

8. A process as defined in any one of claims 1 to 6, wherein the predetermined particle size of the vanadium trioxide powder and the vanadium pentoxide powder is less than 15 microns.

9. A process as defined in any one of the preceding claims, wherein the reactive dissolution is performed at a temperature above 30° C.

10. A process as defined in any one of claims 1 to 8, wherein the reactive dissolution is performed at above 90° C.

11. A process as defined in any one of the preceding claims, wherein the reactive dissolution is conducted for a time of between 10 minutes to 10 hours.

12. A process as defined in any one of claims 1 to 10, wherein the reactive dissolution is conducted for between 0.5 to 3 hours.

13. A process as defined in any one of the preceding claims also comprising the step of reconstituting the mixture of trivalent and tetravalent ions with an acid and/or water to provide the vanadium electrolyte.

14. A process as defined in any one of claims 1 to 12, wherein the vanadium electrolyte is produced directly from the reactive dissolution of the vanadium trioxide and vanadium pentoxide powders in the presence of sulphuric acid.

15. A process as defined in any one of the preceding claims, wherein the total vanadium concentration of the vanadium electrolyte product of this process is between 0.5 and 12 Molar (M).

16. A process as defined in any one of claims 1 to 14, wherein the total vanadium concentration is between 1.5 and 6M or 1.5 and 3 M.

17. A process as defined in claim 16, wherein the total vanadium concentration is between 1.5 and 2 M.

18. A process as defined in any one of claims 2 to 17, wherein the sulphuric acid concentration is between 4 and 6 M.

19. A process as defined in any one of the preceding claims, further comprising the step of stabilising the vanadium electrolyte by the addition of a stabilising agent before, during or after the reactive dissolution.

20. A process as defined in claim 19, wherein the stabilising agent includes ammonium phosphate, ammonium sulphate, phosphoric acid or combinations thereof.

21. A process as defined in any one of the preceding claims wherein the vanadium electrolyte is suitable for use in a vanadium redox battery without further reduction to obtain the required V(III) to V(IV) ratio.
